(19) United States
(12) Patent Application Publication
(10) Pub. No.: US 2007/0228794 A1
(43) Pub. Date: Oct. 4, 2007

(54) AIRCRAFT PASSENGER SEAT

(75) Inventor: James Randy Penley, Pfafftown, NC (US)

Correspondence Address: ADAMS EVANS P.A., Suite 2350 Charlotte Plaza, 201 South College Street, CHARLOTTE, NC, 28244, US

(73) Assignee: BE AEROSPACE, INC., Wellington, FL (US)

(21) Appl. No.: 11/692,447

(22) Filed: Mar. 28, 2007

Related U.S. Application Data
(60) Provisional application No. 60/743,973, filed on Mar. 30, 2006.

(51) Int. Cl. B60N 2/00

(52) U.S. Cl. 297/354.1

(57) ABSTRACT

An aircraft passenger seat includes a laterally extending support beam, a seat bottom frame rotatably mounted on the beam, a seat back frame, and a recline bracket carried on the seat bottom frame for attaching the seat back frame to the seat bottom frame. The recline bracket has an arcuate slot for receiving a laterally extending pin carried on the seat back frame and a pivot is spaced from the arcuate slot such that the seat bottom frame rotates on the beam and the seat back frame pivots about the pivot when the pin moves within the arcuate slot. The pin is positioned at the lower end of an elongate extension of the seat back frame and the pivot is positioned at the upper end of the extension. The passenger seat moves between a full upright position and a fully reclined position as the pin moves within the slot.

### CROSS REFERENCE TO RELATED APPLICATIONS

This application claims the benefit of U.S. Provisional Application No. 60/743,973, filed on Mar. 30, 2006.

### TECHNICAL FIELD AND BACKGROUND OF THE INVENTION

This application relates to an aircraft passenger seat, and more particularly to an aircraft passenger seat for “coach” or main cabin use. The seat is characterized by having a relatively lightweight yet robust structure, relatively few parts compared to other main cabin seats, and a reasonable range of passenger motion within a relatively compact area. The seat makes use of a combination of aluminum, plastic and carbon fiber parts to optimize weight and strength characteristics. The seat has a relatively high pivot point, with a simple linkage assembly between the seat bottom and seat back that controls movement of both elements. The seat has enhanced ergonomic features, such as a spatially optimized initial seating position that enables the seat occupant to easily move between positions.

### SUMMARY OF THE INVENTION

Therefore, it is an object of the invention to provide an aircraft passenger seat that is relatively lightweight.

It is another object of the invention to provide an aircraft passenger seat that is particularly adapted for use in main cabin environments.

It is another object of the invention to provide an aircraft passenger seat that has a range of passenger motion that is compatible with a main cabin environment.

It is another object of the invention to provide an aircraft passenger seat that has an extended range of motion within a relatively compact area, and that promotes passenger comfort by permitting easy seat adjustment.

It is another object of the invention to provide an aircraft passenger seat that is adaptable to a wide range of styles and configurations within a main cabin environment.

In one aspect, the present invention provides a passenger seat including a laterally extending support beam, a seat bottom frame rotatably mounted on the beam, a seat back frame, and a recline bracket carried on the seat bottom frame for attaching the seat back frame to the seat bottom frame. The recline bracket has at least one arcuate slot for receiving a laterally extending pin carried on the seat back frame such that the seat bottom frame rotates on the beam when the pin moves within the slot. A pivot is spaced from the arcuate slot such that the seat back frame pivots about the pivot when the pin moves within the slot.

In other embodiments, the seat back includes an elongate extension having a lower end and an upper end. The pin is positioned at the lower end of the extension and the pivot is positioned at the upper end of the extension. The passenger seat is operable to move between a full upright position and a fully reclined position as the pin moves within the arcuate slot. The arcuate slot limits rearward movement of the seat back frame in the fully reclined position, and a forwardmost end of the seat bottom frame is lowered as the passenger seat is moved from the full upright position to the fully reclined position and the seat bottom frame rotates on the beam.

In other embodiments, at least one of the seat bottom frame and the seat back frame are made of a laminated composite fiber and resin material.

In still other embodiments, the passenger seat further includes a hydraulic piston and cylinder assembly operably attached to the seat bottom frame for selectively positioning the passenger seat between the full upright position and the fully reclined position.

In another aspect, the present invention provides a passenger seat including a laterally extending beam, a seat bottom frame rotatably mounted on the beam, a seat back frame, and a recline bracket for movably attaching the seat back frame to the seat bottom frame. The recline bracket permits a rearward movement of the seat back frame from a full upright position to a fully reclined position accompanied by a rotation of the seat bottom frame on the beam without a forward movement of the seat bottom frame. A forwardmost end of the seat bottom frame is lowered as the seat back frame is moved from the full upright position to the fully reclined position and the seat bottom frame rotates on the beam.

In yet another aspect, the present invention provides a passenger seat for an aircraft. The passenger seat includes a pair of leg assemblies for securing the passenger seat to a floor of the aircraft; a support beam fixed to and extending laterally between the leg assemblies; a seat bottom frame having a pair of collars for rotatably mounting the seat bottom frame on the beam; a seat back frame; a pair of recline brackets carried on the seat bottom frame for attaching the seat back frame to the seat bottom frame, each recline bracket having a pair of spaced-apart, arcuate slots for receiving a laterally extending pin carried on the seat back frame; and a pair of pivots, each pivot spaced from a corresponding one of the pair of the arcuate slots such that the seat back frame pivots about the pivot when the pin moves within the slot. The pin carried on the seat back frame is constrained to move within the arcuate slots and the seat back frame is constrained to rotate about the pivots as the passenger seat is moved between a full upright position and a fully reclined position. Furthermore, the seat bottom frame rotates on the beam and a forwardmost end of the seat bottom frame is lowered as the passenger is moved from the full upright position to the fully reclined position.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 is a perspective view of a two-seat group of passenger seats according to a preferred embodiment of the invention shown with seat top parts removed for clarity;

FIG. 2 is a perspective view of the two-seat group of passenger seats of FIG. 1 shown with seat bottom parts of one of the seats removed for clarity;

FIG. 3 is a perspective view of the two-seat group of passenger seats of FIG. 1 shown with seat bottom parts of both seats removed for clarity;

FIG. 4 is an enlarged, fragmentary view of the linkage assembly between the seat bottom and the seat back;

FIG. 5 is a simplified perspective view of the two-seat group of passenger seats in a fully assembled configuration including a dress cover;

FIG. 6 is a simplified side elevation of a passenger seat according to an embodiment of the invention in the full upright position;

FIG. 7 is a simplified side elevation of a passenger seat according to an embodiment of the invention in a slightly reclined position;

FIG. 8 is a simplified side elevation of a passenger seat according to an embodiment of the invention in the almost fully reclined position;

FIG. 9 is a simplified side elevation of a passenger seat according to an embodiment of the invention in the fully reclined position; and

FIG. 10 is a simplified composite side elevation of a passenger seat according to an embodiment of the invention showing overlaid full upright and fully reclined positions.

### DESCRIPTION OF THE PREFERRED EMBODIMENTS AND BEST MODE

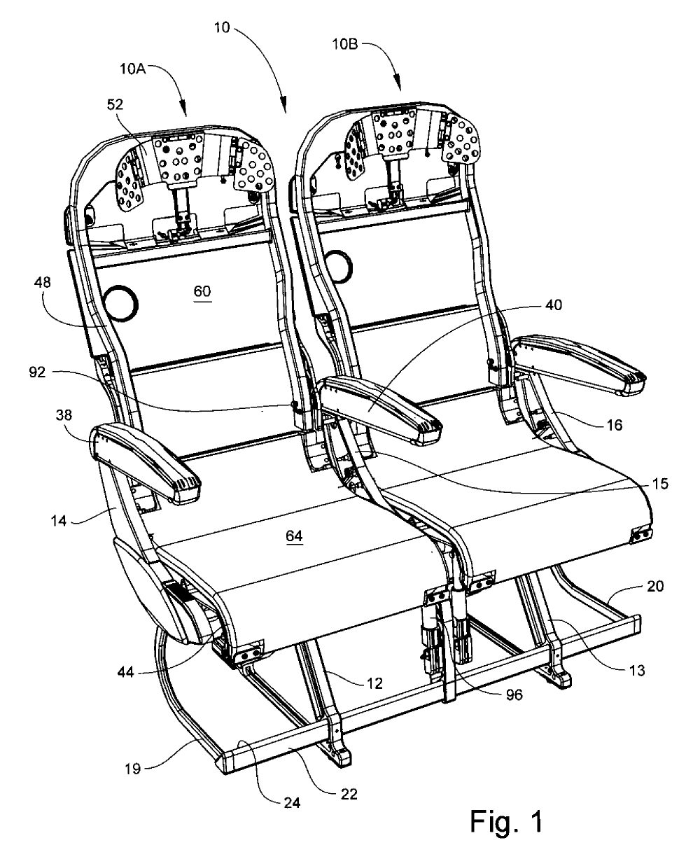

Referring now specifically to the drawings, a two-seat group of passenger seats 10 comprised of individual seats 10A, 10B according to the present invention is shown generally in FIGS. 1, 2 and 3. The invention is described and explained with reference to the seat 10A, it being understood that seat 10B is constructed and functions in the same manner.

Seats such as seat 10A are conventionally referred to as “coach” or “main cabin” seating, as distinct from larger and more complex “first class” or “business class” seating. As will be seen below, however, certain features of this invention are also applicable to first class and business class seating. The seat group 10 includes a pair of leg assemblies 12 and 13 for being attached to a supporting surface by means of conventional track fittings, such as are disclosed in U.S. Pat. Nos. 4,776,533; 5,169,091; and 5,871318. Seat frames 14, 15, and 16 are connected by single laterally-extending beam 18. Baggage guard rails 19 and 20 prevent baggage stowed under the seats 10A, 10B, from sliding sideways into an adjacent aisle. A footrest 22 attaches to the forward ends of the baggage guard rails 19, 20 and extends laterally across the front of the seat group 10. In accordance with a preferred embodiment of the invention, the footrest 22 has a rearward-facing, upwardly angled surface 24 that provides an anatomically appropriate angle for supporting the feet of an aft-seated passenger as well as preventing baggage stowed under the seat from sliding forward into the space occupied by the passenger seated in seat 10A or 10B.

The beam 18 provides support to the seat group 10 and the individual seats 10A, 10B. The leg assemblies 12, 13 are rigidly mounted on the beam 18 by respective clamp fittings 26, 28. The beam 18 is movably supported on the seat frames 14, 15 and 16 by collar 30 carried by seat frame 14, collars 32, 34 carried by seat frame 15, and collar 36 carried by seat frame 16. Alternatively, a pair of beams, one for each seat 10A, 10B may be used.

Two armrests 38, 40, are provided for seat 10A, the center armrest 40 being shared with seat 10B.

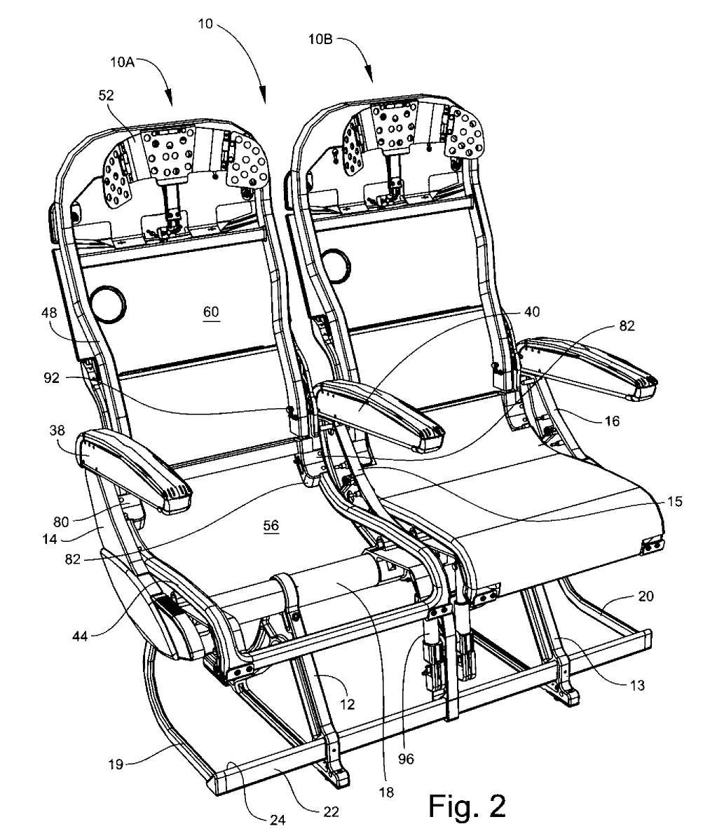

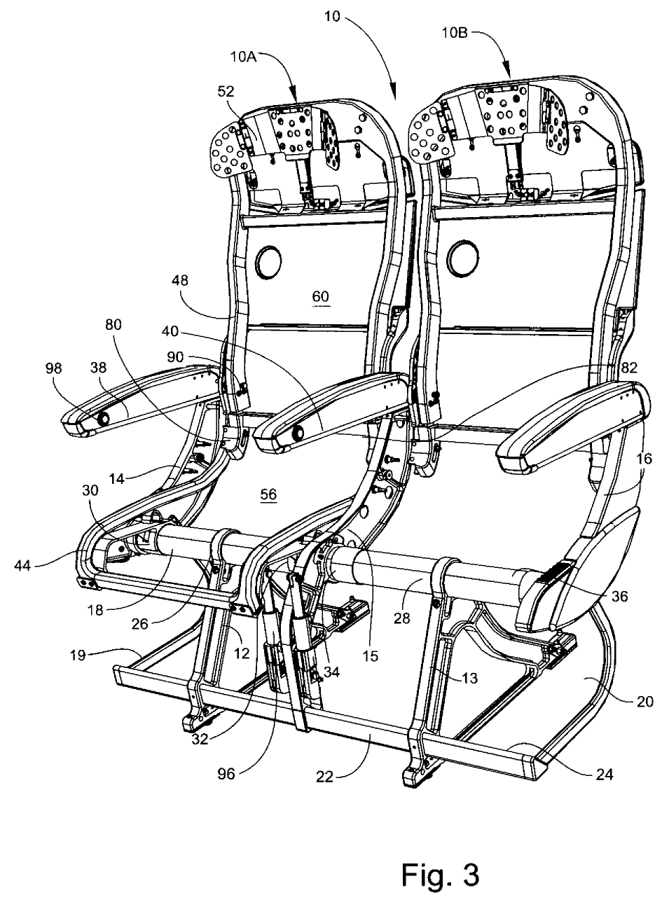

As best shown in FIGS. 2 and 3, seat 10A includes a seat bottom frame 44 carried by seat frame 14 and seat frame 15, and further includes a seat back frame 48. The seat bottom frame 44 and the seat back frame 48 are preferably fabricated of a controlled flex material, such as a laminated composite carbon fiber resin. This material is well-known as a lightweight, durable and relatively inert material particularly suited for aircraft use. Head rest 52 is adjustably mounted on the upper end of the respective seat back frame 48.

The seat bottom frame 44 supports a seat pan 56 (see FIG. 3) and the seat back frame 48 is covered with either a thin aluminum sheet or fabric diaphragm 60 that serves as a resilient surface.

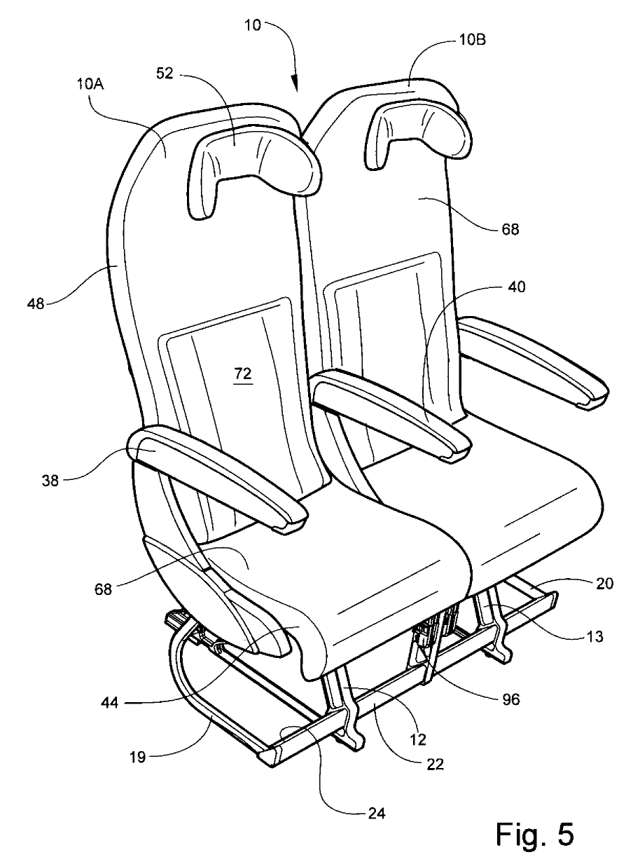

As is best shown in FIG. 3, passenger comfort is enhanced by use of conventional foam padding, or preferably, by additional lightweight cushioning material, such as one of several synthetic fiber, three-dimensional pads, such as pad 64 (see FIG. 1) overlying the seat pan 56. The seat 10A is then covered with dress cover 68. As is shown in FIG. 5, an exterior lumbar pad 72 may be used to provide further comfort.

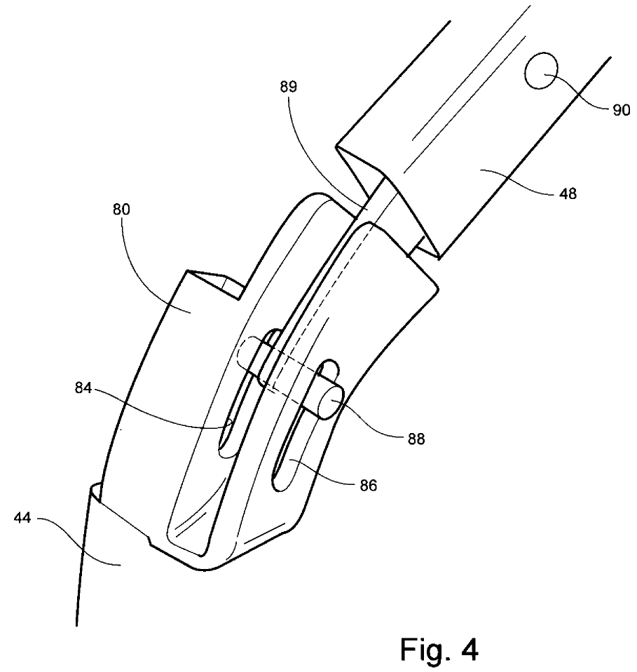

Referring to FIGS. 1-4, seat 10A has a recline feature that provides an acceptable degree of recline for the seat back frame 48, while eliminating forward movement of the seat bottom frame 44. This is accomplished by providing a relatively high seat back pivot point and a centrally-positioned seat bottom pivot point. More specifically, as is best shown in FIGS. 3 and 4, seat 10A includes recline brackets 80, 82 carried on the rearward (aft) ends of the seat bottom frame 44. As is shown in FIG. 4 with reference to bracket 80, a pair of aligned, slightly curved (i.e. arcuate) slots 84, 86 in the bracket 80 captures a laterally-positioned pin 88 carried on the end of an extension 89 secured to the adjacent lower end of the seat back frame 48. Thus, the seat back frame 48 is allowed to move according to the length of the arcuate slots 84, 86. The seat back frame 48 pivots about pivot pins 90, 92. Bracket 82 is the mirror image of bracket 80 and functions identically and in unison with bracket 80. The brackets 80, 82 therefore connect the seat bottom frame 44 and seat back frame 48, and limit their pivotal and translational movement relative to each other.

The seat bottom frame 44 moves by being attached to the beam collars 30, 32 into which beam 18 is inserted. Beam 18 is held in a fixed, non-rotational position by the clamp fitting 26. The beam collars 30, 32 are permitted to rotate slightly on the beam 18 by rocking movement of the seat bottom frame 44.

The seat 10A is arrested in the full upright or desired reclined position by a piston and cylinder assembly 96, mounted at one end to the seat frame 15 and at the other end to an adjacent part of the seat bottom frame 44. A hydraulic cylinder, commercially known as a “Hydrolok®” cylinder manufactured by Crane Aerospace & Electronics, is suitable for use as the piston and cylinder assembly 96. The piston and cylinder assembly 96 is controlled by a button 98 on the medial side of the armrest 38. Alternatively, a mechanical lock can be utilized.

In view of the foregoing description, operation of the seat 10A is next explained, noting again that this explanation applies equally to seat 10B. Referring now to FIGS. 5-10, the overall movement of the seat 10A is such that as the seat back frame 48 is reclined, the seat bottom frame 44 rocks forward slightly such that the forwardmost end of the seat bottom frame 44 directly behind the knees of the passenger is lowered. Thus, the simultaneous rearward movement of the seat back frame 48 and the lowering of seat bottom frame 44 allows the seat occupant to unbend from the waist. In other words, the seat occupant is allowed to stretch so that the body is less bent and somewhat straighter that when sitting upright.

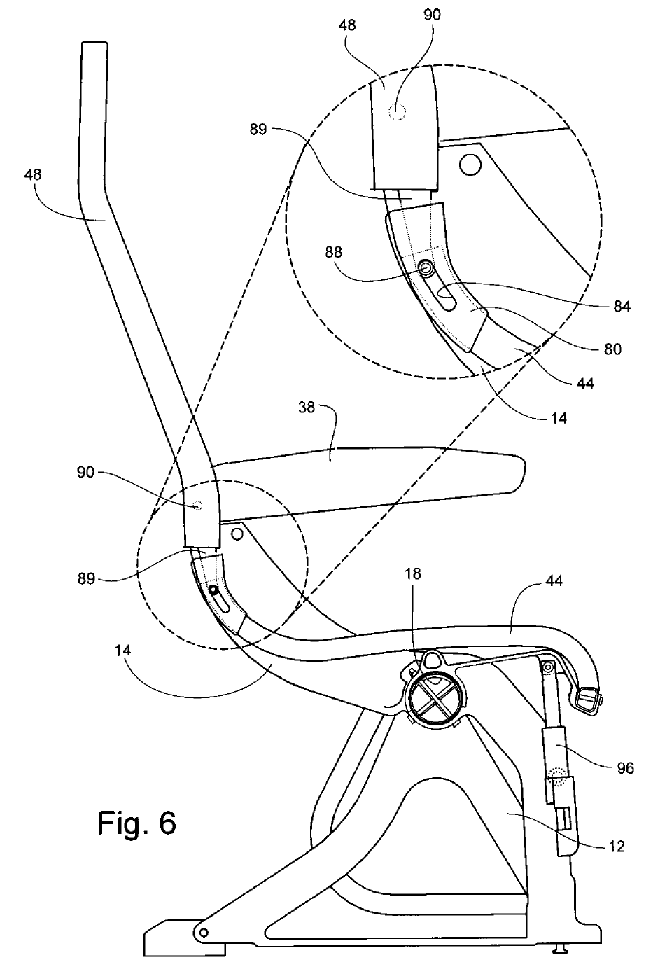

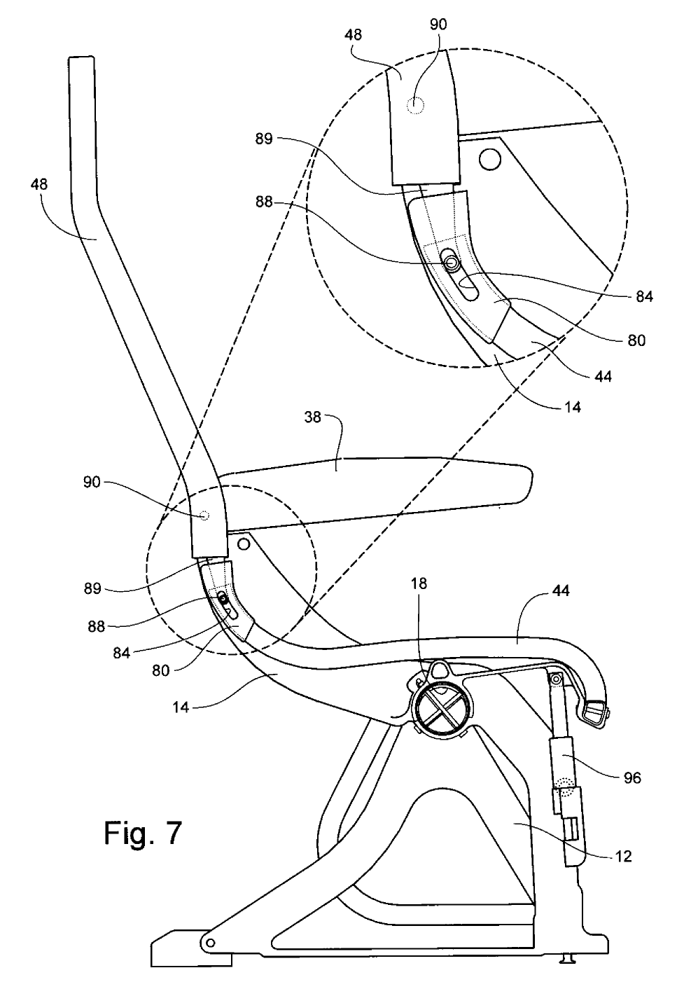

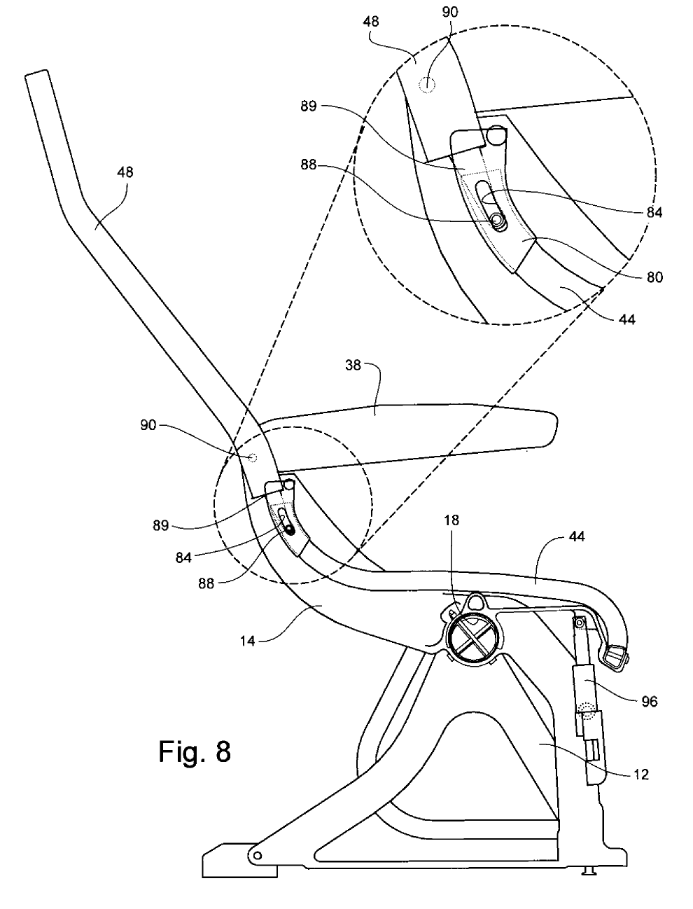

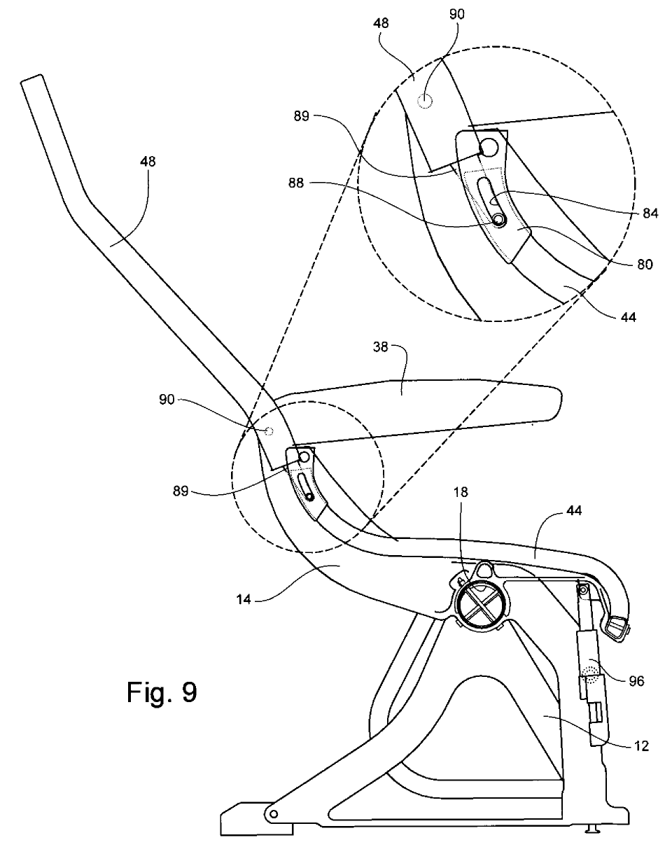

FIG. 5 shows seats 10A and 10B in the full upright position. By reference to FIGS. 6-10 the movement of both seat 10A and 10B is explained by reference to seat 10A. Note in FIG. 6 that in the full upright position shown, the pin 88 is in the uppermost end of slots 84, 86, with only slot 84 being visible. In FIG. 7 the seat back frame 48 has reclined slightly and the seat bottom frame 44 has rocked forward slightly. Note the position of the pin 88, now slightly below the upper extent of slot 84. In FIG. 8, the seat back frame 48 is almost to its fully reclined position, the seat bottom frame 44 has rocked further forward, further lowering the forwardmost end of the seat bottom frame 44, and the pin 88 has moved relative to the slot 84 to the point where the pin 88 is almost at the bottom end of the slot 84. Finally, FIG. 9 shows the seat 10A in full recline, with the seat back frame 48 in its fully reclined position, the forwardmost end of the seat bottom frame 44 rocked forward to its lowest position, and the pin 88 moved relative to the slot 84 to the point where the pin 88 is at the bottom of the slot 84. The engagement of the pin 88 with the bottom of the slot 84 provides a mechanical stop that limits further rearward movement of the seat back frame 48.

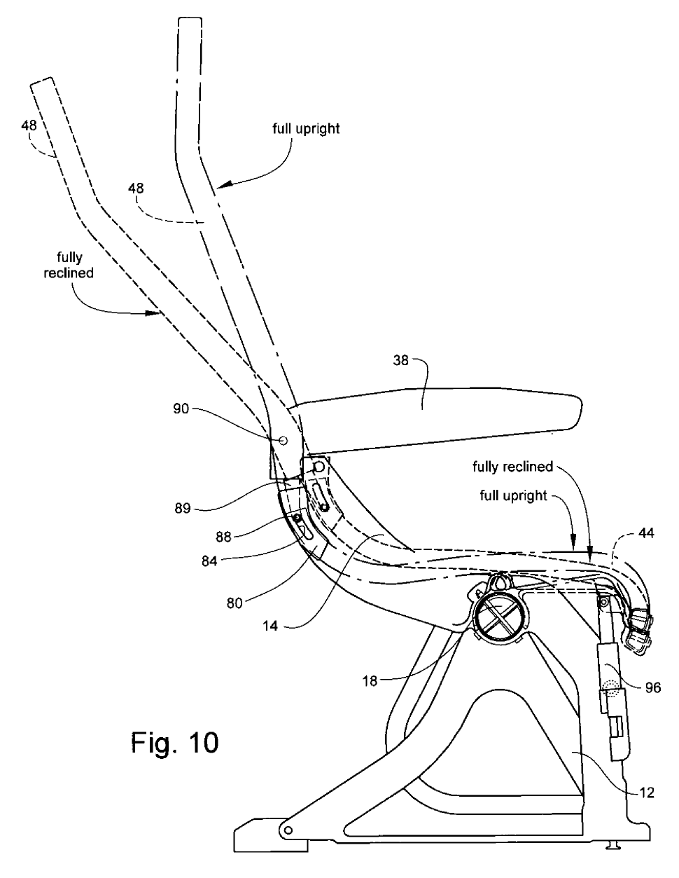

FIG. 10 shows seat 10A in both its full upright and fully reclined positions. With the seat 10A in the full upright position, as indicated, the seat back frame 48 is forward and the forwardmost end of the seat bottom frame 44 is in a raised position. With the seat 10A in the fully reclined position, the seat back frame 48 is reclined rearward, and the forwardmost end of the seat bottom frame 44 is somewhat lowered, as described above.

An improved aircraft passenger seat is described above. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

What is claimed is:

1. A passenger seat comprising:
(a) a laterally extending support beam;
(b) a seat bottom frame rotatably mounted on the beam;
(c) a seat back frame; and
(d) a recline bracket carried on the seat bottom frame for attaching the seat back frame to the seat bottom frame, the recline bracket having at least one arcuate slot for receiving a laterally extending pin carried on the seat back frame such that the seat bottom frame rotates on the beam when the pin moves within the slot.

2. The passenger seat of claim 1, further comprising a pivot spaced from the arcuate slot and wherein the seat back frame pivots about the pivot when the pin moves within the slot.

3. The passenger seat of claim 2, wherein the seat back frame comprises an elongate extension having a lower end and an upper end and wherein the pin is positioned at the lower end of the extension and the pivot is positioned at the upper end of the extension.

4. The passenger seat of claim 1, wherein the passenger seat is operable to move between a full upright position and a fully reclined position as the pin moves within the arcuate slot.

5. The passenger seat of claim 4, wherein the arcuate slot limits a rearward movement of the seat back frame in the fully reclined position.

6. The passenger seat of claim 5, wherein a forwardmost end of the seat bottom frame is lowered as the passenger seat is moved from the full upright position to the fully reclined position and the seat bottom frame rotates on the beam.

7. The passenger seat of claim 1, wherein at least one of the seat bottom frame and the seat back frame are made of a laminated composite fiber and resin material.

8. The passenger seat of claim 1, further comprising a hydraulic piston and cylinder assembly operably attached to the seat bottom frame for selectively positioning the passenger seat between a full upright position and a fully reclined position.

9. A passenger seat comprising:
(a) a laterally extending beam;
(b) a seat bottom frame rotatably mounted on the beam;
(c) a seat back frame; and
(d) a recline bracket for movably attaching the seat back frame to the seat bottom frame;
wherein the recline bracket permits a rearward movement of the seat back frame from a full upright position to a fully reclined position accompanied by a rotation of the seat bottom frame on the beam without a forward movement of the seat bottom frame.

10. The passenger seat of claim 9, wherein a forwardmost end of the seat bottom frame is lowered as the seat back frame is moved from the full upright position to the fully reclined position and the seat bottom frame rotates on the beam.

11. The passenger seat of claim 9, wherein the seat back frame comprises an elongate extension having a laterally extending pin and wherein the recline bracket has an arcuate slot for receiving the pin such that the pin is constrained to move within the slot.

12. The passenger seat of claim 11, further comprising a pivot spaced from the arcuate slot and wherein the seat back frame pivots about the pivot when the pin moves within the slot.

13. The passenger seat of claim 13, wherein the arcuate slot limits the rearward movement of the seat back frame in the fully reclined position.

14. The passenger seat of claim 9, wherein at least one of the seat bottom frame and the seat back frame are made of a laminated composite fiber and resin material.

15. The passenger seat of claim 9, further comprising a hydraulic piston and cylinder assembly operably attached to the seat bottom frame for selectively positioning the passenger seat between the full upright position and the fully reclined position.

16. A passenger seat for an aircraft, the passenger seat comprising:
(a) a pair of leg assemblies for securing the passenger seat to a floor of the aircraft;
(b) a support beam fixed to and extending laterally between the leg assemblies;
(c) a seat bottom frame having a pair of collars for rotatably mounting the seat bottom frame on the beam;
(d) a seat back frame;
(e) a pair of recline brackets carried on the seat bottom frame for attaching the seat back frame to the seat bottom frame, each recline bracket having a pair of spaced-apart, arcuate slots for receiving a laterally extending pin carried on the seat back frame; and
(f) a pair of pivots, each pivot spaced from a corresponding one of the pair of the arcuate slots such that the seat back frame pivots about the pivot when the pin moves within the slot.

17. The passenger seat of claim 16, wherein the pin carried on the seat back frame is constrained to move within the arcuate slots and the seat back frame is constrained to rotate about the pivots as the passenger seat is moved between a full upright position and a fully reclined position.

18. The passenger seat of claim 17, wherein the seat bottom frame rotates on the beam and a forwardmost end of the seat bottom frame is lowered as the passenger is moved from the full upright position to the fully reclined position.

19. The passenger seat of claim 17, wherein the arcuate slots limit the rearward movement of the seat back frame in the fully reclined position.

20. The passenger seat of claim 16, wherein the seat back frame comprises a pair of elongate extensions, each extension having a lower end and an upper end and wherein the pin is positioned at the lower end of the extension and the pivot is positioned at the upper end of the extension.
